(19) United States
(12) Patent Application Publication
(10) Pub. No.: US 2017/0184800 A1
(43) Pub. Date: Jun. 29, 2017

(54) FERRULE FOR MULTI-FIBER OPTICAL CONNECTOR

(71) Applicant: Corning Optical Communications LLC, Hickory, NC (US)

(72) Inventors: Michael de Jong, Colleyville, TX (US); Paul Anthony Fleenor, Hickory, NC (US); David Wayne Meek, Fort Worth, TX (US); Robert Max Sanetick, Denver, NC (US); Grzegorz Tosik, Buczek (PL)

(21) Appl. No.: 15/459,341

(22) Filed: Mar. 15, 2017

Related U.S. Application Data
(63) Continuation of application No. PCT/US2015/051363, filed on Sep. 22, 2015.
(60) Provisional application No. 62/056,841, filed on Sep. 29, 2014.

(51) Int. Cl. G02B 6/38

(52) U.S. Cl. CPC G02B 6/3885; G02B 6/3882; G02B 6/3887; G02B 6/3821; G02B 6/3825; G02B 6/3893

(57) ABSTRACT

A ferrule for a multi-fiber optical connector includes a body extending in a longitudinal direction between a front end and a back end. The front end of the body defines a first end face and at least one additional endface offset from the first end face in the longitudinal direction. The ferrule also includes first and second groups of micro-holes extending into the body from the at least one additional end face. Each micro-hole is configured to receive one of the optical fibers. The first and second groups of micro-holes are spaced apart from each other by distance greater than spacing between the micro-holes in the first and second groups themselves, thereby defining a space between an innermost micro-hole in the first group and an innermost micro-hole in the second group. The space itself is free of micro-holes.

### PRIORITY APPLICATION

This application is a continuation of PCT/US2015/051363, filed on Sep. 22, 2015, which claims the benefit of priority of U.S. Provisional Application Ser. No. 62/056,841, filed on Sep. 29, 2014. The content of both applications is relied upon and incorporated herein by reference in its entirety.

### BACKGROUND

This disclosure relates generally to optical fibers, and more particularly to ferrules for multi-fiber optical connectors, along with optical connectors and cable assemblies including such ferrules.

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, optical connectors are often provided on the ends of fiber optic cables. The process of terminating individual optical fibers from a fiber optic cable is referred to as “connectorization.” Connectorization can be done in a factory, resulting in a “pre-connectorized” or “pre-terminated” fiber optic cable, or the field (e.g., using a “field-installable” connectors).

Many different types of optical connectors exist. In environments that require high density interconnects and/or high bandwidth, such as datacenters, multi-fiber optical connectors are the most widely used. One example is the multi-fiber push on (MPO) connector, which incorporates a mechanical transfer (MT) ferrule and is standardized according to TOA-604-5 and IEC 61754-7. These connectors can achieve a very high density of optical fibers, which reduces the amount of hardware, space, and effort to establish a large number of interconnects.

Despite the widespread use of MPO connectors in datacenter environments, there are still challenges/issues to address. For example, although MPO connectors may contain any even number of fibers between 4 and 24 within the same physical package, 12-fiber connectors are the most commonly used. For some applications, such as parallel optics for 40 Gps Ethernet, only 8 active fibers are needed. Conversion modules may be used to convert the unused fibers from two or more MPO connectors into usable optical links (e.g., converting 4 unused fibers from each of two MPO connectors into 8 useable optical links), but the conversion adds costs to a network. Alternatively, cable assemblies can be built with only 8-fibers terminated by an MPO connector, but the MPO connector still resembles a 12-fiber connector. In other words, it can be difficult to see with the naked eye whether 8 fibers or 12 fibers are present. This uncertainty in fiber count may result in network issues if a connector with 12 active fibers is inadvertently mated to a connector with only 8 active fibers.

In some commercially available products, a portion of the ferrule may be marked via ink stamping or embossed with a character to indicate fiber count. However, these marks may be cryptic and are not visible to the user once the ferrule is assembled into a connector.

### SUMMARY

Embodiments of a ferrule for an optical connector are disclosed below. According to one embodiment, the ferrule includes a body extending in a longitudinal direction between a front end and a back end. The front end of the body defines a first end face and at least one additional endface offset from the first end face in the longitudinal direction. The ferrule also includes first and second groups of micro-holes extending into the body from the at least one additional end face. Each micro-hole is configured to receive an optical fiber. The first and second groups of micro-holes are spaced apart from each other by distance greater than spacing between the micro-holes in the first and second groups themselves, thereby defining a space between an innermost micro-hole in the first group and an innermost micro-hole in the second group. The space itself is free of micro-holes.

Additional features and advantages will be set forth in the detailed description which follows, and in part will be readily apparent to those skilled in the technical field of optical communications. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 a perspective view of an example of a fiber optic connector;

FIG. 2 is an exploded perspective view of the fiber optic connector of FIG. 1;

FIG. 3 is a perspective view of an alternative embodiment of a ferrule for a fiber optic connector, such as the fiber optic connector of FIG. 1;

FIG. 4 is a cross-sectional view of the ferrule of FIG. 3;

FIG. 5 schematically shows alternative embodiments of a ferrule for a fiber optic connector; and

FIG. 6 is schematically shows further embodiments of a ferrule for a fiber optic connector.

### DETAILED DESCRIPTION

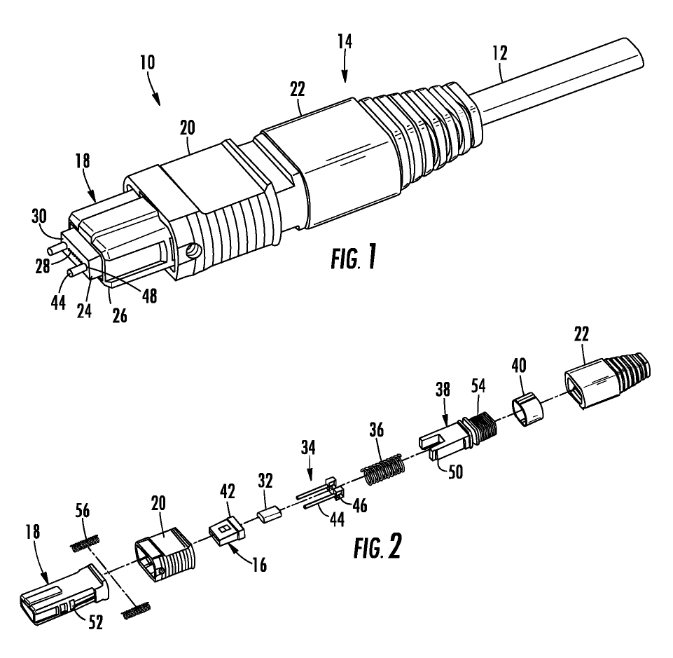

Various embodiments will be further clarified by examples in the description below. In general, the description relates to multi-fiber ferrules and fiber optic connectors and cable assemblies incorporating such multi-fiber ferrules. The fiber optic connectors may be based on known connector designs, such as MPO connectors. To this end, FIGS. 1 and 2 illustrate a fiber optic connector 10 (also referred to as “optical connector” or simply “connector”) in the form of a MTP® connector, which is particular type of MPO connector (MTP® is a trademark of US Conec Ltd.). A brief overview of the connector 10 will be provided to facilitate discussion, as the multi-fiber ferrules and other components shown in subsequent figures may be used in connection with the same type of connector. However, persons skilled in the field of optical connectivity will appreciate that the connector 10 is merely an example, and that the general principles disclosed with respect to the multi-fiber ferrules and other components shown in subsequent figures may also be applicable to other connector designs.

As shown in FIG. 1, the connector 10 may be installed on a fiber optic cable 12 (“cable”) to form a fiber optic cable assembly 14. The connector includes a ferrule 16, a housing 18 received over the ferrule 16, a slider 20 received over the housing 18, and a boot 22 received over the cable 12. The ferrule 16 is spring-biased within the housing 18 so that a front portion 24 of the ferrule 16 extends beyond a front end 26 of the housing 18. Optical fibers (not shown) carried by the cable 12 extend through micro-holes or bores 28 in the ferrule 16 before terminating at or near an end face 30 of the ferrule 16. The optical fibers are secured within the ferrule 16 using an adhesive material (e.g., epoxy) and can be presented for optical coupling with optical fibers of a mating component (e.g., another fiber optic connector; not shown) when the housing 20 is inserted into an adapter, receptacle, or the like.

As shown in FIG. 2, the connector 10 also includes a ferrule boot 32, guide pin assembly 34, spring 36, crimp body 38, and crimp ring 40. The ferrule boot 32 is received in a rear portion 42 of the ferrule 16 to help support the optical fibers extending to the ferrule bores 28 (FIG. 1). The guide pin assembly 34 includes a pair of guide pins 44 extending from a pin keeper 46. Features on the pin keeper 46 cooperate with features on the guide pins 44 to retain portions of the guide pins 44 within the pin keeper 46. When the connector 10 is assembled, the pin keeper 46 is positioned against a back surface of the ferrule 16, and the guide pins 44 extend through pin holes 48 (FIG. 1) provided in the ferrule 16 so as to project beyond the front end face 30.

Both the ferrule 16 and guide pin assembly 34 are biased to a forward position relative to the housing 18 by the spring 36. More specifically, the spring 36 is positioned between the pin keeper 46 and a portion of the crimp body 38. The crimp body 38 is inserted into the housing 18 when the connector 10 is assembled and includes latching arms 50 that engage recesses 52 in the housing. The spring 36 is compressed by this point and exerts a biasing force on the ferrule 16 via the pin keeper 46. The rear portion 42 of the ferrule defines a flange that interacts with a shoulder or stop formed within the housing 18 to retain the rear portion 42 within the housing 18.

In a manner not shown in the figures, aramid yarn or other strength members from the cable 12 are positioned over an end portion 54 of the crimp body 38 that projects rearwardly from the housing 18. The aramid yarn is secured to the end portion 54 by the crimp ring 40, which is slid over the end portion 54 and deformed after positioning the aramid yarn. The boot 22 covers this region, as shown in FIG. 1, and provides strain relief for the optical fibers by limiting the extent to which the connector 10 can bend relative to the cable 12. The word “PUSH” is printed on the boot 22 in the embodiment shown to help direct a user to grasp the boot 22 when inserting the connector 10 into an adapter or receptacle, thereby allowing the housing to be fully inserted for proper engagement/mating with the adapter or receptacle. The word “PULL” is printed on the slider 20, which may be biased by springs 56 (FIG. 2) relative to the housing 18, to help direct a user to grasp the slider 20 when disengaging the connector 10 from an adapter or receptacle. This way pull forces are transferred directly to the housing 18 (rather than the cable 12) to disengage the housing 18 from the adapter or receptacle.

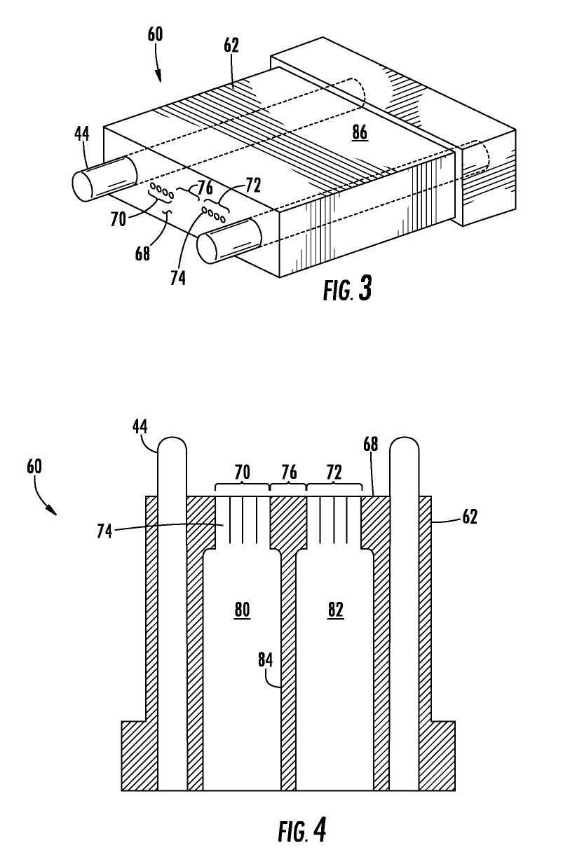

Now that a general overview of the connector 10 has been provided, alternative ferrule designs will be described. To this end, FIGS. 3 and 4 illustrate a ferrule 60 according to an alternative embodiment. Guide pins 44 are schematically illustrated as well, but other components of the connector 10 are not shown for clarity.

The ferrule 60 includes a body 62 extending in a longitudinal direction (i.e., along a longitudinal axis) between front and back ends of the body 62. The front end defines a front end face 68. First and second groups 70, 72 of micro-holes 74 extend into the body 62 from the front end face 68. Each micro-hole 74 is configured to receive an optical fiber (not shown), similar to the micro-holes 28 of the ferrule 16. In the embodiment of FIGS. 1 and 2, however, the first and second groups 70, 72 of micro-holes 74 are spaced apart from each other by distance greater than spacing between the micro-holes 74 in the first and second groups 70, 72 themselves. Thus, a space 76 is defined between an innermost micro-hole 74 in the first group 70 and an innermost micro-hole 74 in the second group 72, with the space 76 itself being free of micro-holes.

As shown in FIG. 4, the micro-holes 74 open into respective first and second chambers 80, 82 extending into the body 62 from the back end of the ferrule 60. A partition 84 separates the first and second chambers 80, 82. In alternative embodiments, the micro-holes 74 may open into a common chamber. Embodiments are also possible where the micro-holes 74 extend completely though the ferrule 60 (i.e., between the front end and back end of the ferrule 60). An advantage of providing the first and second chambers 80, 82, however, is that the first and second chambers 80, 82 can each be configured to accommodate a four-fiber ribbon (not shown). Only a short length of the ribbon needs to be stripped of ribbon matrix material to expose the four optical fibers so that, once cleaned, the optical fibers can extend into the micro-holes 74. Features can also be provided in the first and second chambers 80, 82 to help guide the optical fibers into the respective micro-holes 74 during insertion. Handling a four-fiber ribbon to align four optical fibers with four micro-holes is easier than the conventional approach of handling a 12-fiber ribbon to align 12 fibers with 12 micro-holes.

The body 62 of the ferrule 60 includes an outer surface 86 (FIG. 3) extending between the front and back ends of the body 62. In a manner not shown, the ferrule 60 may include one or more openings extending through the outer surface 86 of the body 62 so that an adhesive material may be applied to optical fibers received in the body 62. For example, a first opening may extend through the outer surface 86 of the body 62 to the first chamber 80 (and/or first group 70 of micro-holes 74), and a second opening may extend through the outer surface 86 to the second chamber 82 (and/or second group 70 of micro-holes 74). Alternatively, a common opening may extend through the outer surface 86 to the first and second chambers 80, 82 (and/or first and second groups 70, 72 of micro-holes 74). With the first and second chambers 80, 82 defining a smaller overall volume within the body 62 compared to a common chamber, the amount of adhesive material required to bond the optical fibers is reduced. In some embodiments, the body 62 may be over-molded directly onto the optical fibers such no adhesive material (or openings in the outer surface 86 for such adhesive material) is required.

There are four micro-holes 74 in each of the first and second groups 70, 72 in the embodiment shown. Thus, the ferrule 60 is designed to accommodate 8 optical fibers. Such a configuration is particularly suited for parallel optics applications for 40 Gps transmission in that there are no unused optical fibers or empty micro-holes. In alternative embodiments, the first and second groups 70, 72 may have a different number of micro-holes 74, such as 10 each. The first group 70 may even have a different number of micro-holes 74 than the second group 72 in some embodiments. Furthermore, the micro-holes 74 in each of the first and second groups 70, 72 may be arranged in a line (as shown), array, or any other pattern on the front end face 68 of the ferrule 60.

To quickly identify the ferrule 60 as being different than the ferrule 16, the geometry of the front end face 68 of the ferrule 60 may be modified. For example, FIG. 5 illustrates different embodiments of the ferrule 60 where the front end of the body 62 defines a first end face 90 and at least one additional endface 92 offset from the first end face 90 in the longitudinal direction along which the body 62 extends. The first and second groups 70, 72 of micro-holes 74 extend from the additional end face(s) 92 and into the body 62.

The additional endface(s) 92 may comprise second and third end faces 92a, 92b, as illustrated by the upper two embodiments in FIG. 5, with the first group 70 of micro-holes 74 extending into the body 62 from the second end face 92a and the second group 72 of micro-holes 74 extending into the body 62 from the first end face 68. The second and third end faces 92a, 92b are offset from the first end face 68 in a similar manner (e.g., by the same distance in the longitudinal direction of the body 62). However, the second and third end faces 92a, 92b are spaced apart from each other so as to define a gap between the second and third end faces 92a, 92b. The gap occupies a portion (and perhaps even most) of the space 76 defined between the innermost micro-holes 74 in the first and second groups 70, 74.

Alternatively, and as shown in the lower embodiment in FIG. 5, the additional endface(s) 92 may comprise a common additional end face (or “second end face”) 92 from which both the first and second groups 70, 72 of micro-holes 74 extend. The common additional end face 92 occupies the space 76 between the innermost micro-hole 74 in the first group 70 and the innermost micro-hole 74 in the second group 72. Portions of the common additional end face 92 from which the first and second groups 70, 72 of micro-holes 74 extend are enlarged relative to a portion of the common additional end face 92 occupying the space 76. To this end, the common additional end face 92 is bone-shaped or has an eight-shaped profile.

Different shapes/geometries for the additional end face(s) 92 will be appreciated. For example, and as illustrated in FIG. 5, the additional end face(s) 92 may be rectangular, non-rectangular, elliptical, etc. Additionally, when there are two or more additional end faces 92, the additional end faces 92 may have substantially the same shape (i.e., appear the same with the naked eye) or different shapes. Regardless, the presence of the additional end face(s) 92 and offset from the first end face 68 allows quick visualization to determine that the ferrule 60 and/or connector including the ferrule 60 have something other than a conventional, 12-fiber count/arrangement. Particular geometries may be associated with particular fiber counts to further assist with the determination (e.g., a first shape may indicate an 8-fiber count, a second shape may indicate a 10-fiber count, and so on . . . ). The determination can easily be made even when a connector is assembled, as the front end of the ferrule 60 remains visible through a front opening of a housing in most connector designs.

Another advantage associated with the additional end face(s) 92 is that the amount of ferrule material surrounding the micro-holes 74 is less compared to conventional designs. Many ferrules, and particularly MT ferrules for MPO connectors, are polished after inserting and securing optical fibers in the micro-holes of the ferrule. The polishing is done in a manner that preferentially removes ferrule material from the end face of the ferrule relative to ends of the optical fibers, which are substantially flush with the end face prior to the preferential removal of ferrule material. The polishing process ultimately results in the optical fibers protruding slightly past the end face to ensure physical contact (and optical coupling) with the optical fibers of a mating connector or component. Thus, by having the micro-holes 74 extend from one or more additional end faces 92 that have a smaller area compared to the entire frontal area of the ferrule 60, the amount of material that may need to be removed during polishing is reduced. This may enable short, less-aggressive polishing processes that reduce processing time and the amount of ferrule material initially required.

Furthermore, having the micro-holes 74 extend from one or more additional end faces 92 that have a smaller area compared to the entire frontal area of the ferrule 60 may reduce the sensitivity of a connector to contamination from particulates. In particular, the presence of particulates between a mated pair of ferrules can prevent physical contact between the optical fibers of the ferrule and detrimentally affect optical performance. Multi-fiber ferrules can be particularly at risk to such events due to relatively large contact areas of their end faces. Thus, by having one or more additional end faces 92 that reduce the overall contact area in a mated pair of the ferrules 60, the potential for particulates to prevent physical contact between the optical fibers is reduced.

In the embodiments shown in FIG. 5, the additional end faces 92 include the pin holes 48 (i.e., the pin holes 48 extend into the body 62 from the additional end face(s) 92). The pin holes 48 are empty such that the embodiments represent a female configuration of the ferrule 60. For a male configuration, respective guide pins (not shown in FIG. 5) may be received in the pin holes 48 and project beyond the additional end face(s) 92. Although two pin holes 48 are shown in FIG. 5, any number of pin holes 48 may be provided in alternative embodiments.

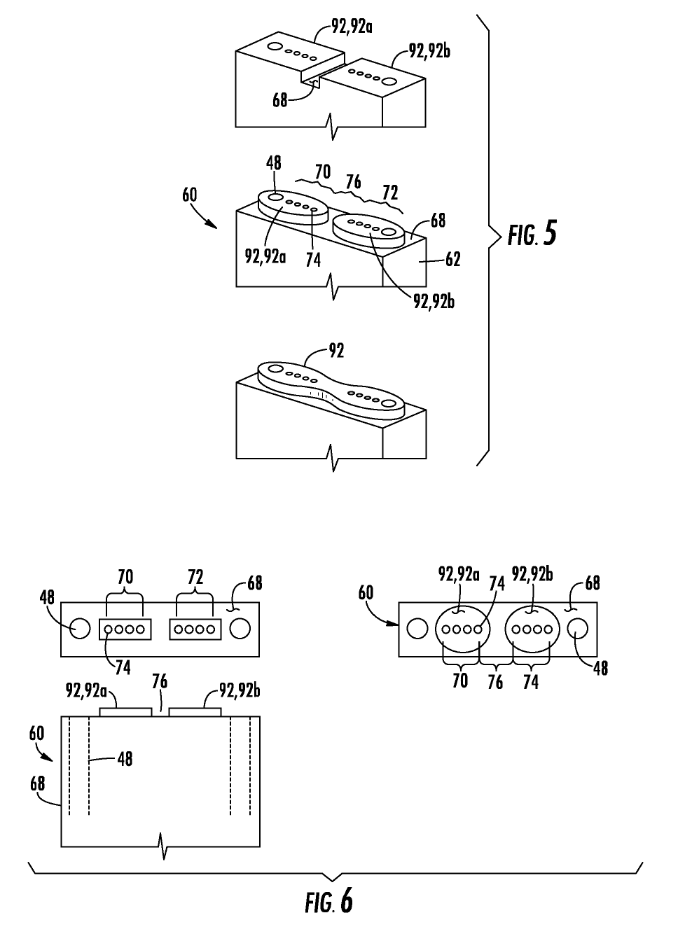

FIG. 6 illustrates how the pin holes 48 can extend into the ferrule 60 from the first end face 68 rather than the additional end face(s) 92 in alternative embodiments. Again, the pin holes 48 are empty such that the embodiments shown represent a female configuration of the ferrule 60. For a male configuration, respective guide pins (not shown in FIG. 6) may be received in the pin holes 60 and project beyond not only the first end face 68, but also the additional end face(s) 92. Having the pin holes 48 extend into the ferrule 60 from the first end face 68 may further reduce the sensitivity of a connector to contamination from particulates in that a greater percentage of dust, dirt, and other debris often accumulate around the pin holes 48 compared to other portions of the front end of the ferrule 60. This area being recessed from the additional end face(s) 92, which represent the mating surface(s) of the ferrule 60, reduces the likelihood of particulates preventing physical contact between the optical fibers in a mater pair of the ferrules 60. Additionally, the offset arrangement of the additional end face(s) 92 may make them easier to access and clean in a male configuration due to improved access around the guide pins.

Persons skilled in optical connectivity will appreciate additional variations and modifications of the devices and methods already described.

What is claimed is:

1. A ferrule for an optical connector that can include multiple optical fibers, the ferrule comprising:
a body extending in a longitudinal direction between a front end and a back end, the front end defining a first end face and at least one additional endface offset from the first end face in the longitudinal direction; and
first and second groups of micro-holes extending into the body from the at least one additional end face, each micro-hole being configured to receive one of the optical fibers;
wherein the first and second groups of micro-holes are spaced apart from each other by distance greater than spacing between the micro-holes in the first and second groups themselves, thereby defining a space between an innermost micro-hole in the first group and an innermost micro-hole in the second group, and further wherein the space itself is free of micro-holes.

2. A ferrule according to claim 1, further comprising:
at least one guide pin hole extending into the body from the at least one additional end face.

3. A ferrule according to claim 1, further comprising:
at least one guide pin hole extending into the body from the first end face.

4. A ferrule according to claim 1, further comprising:
at least one chamber extending into the body from the back end, wherein the first and second groups of micro-holes open into the chamber.

5. A ferrule according to claim 4, wherein the at least one chamber comprises a first chamber and second chamber such that the body defines a partition between the first and second chambers, the first group of micro-holes opening into the first chamber, and the second group of micro-holes opening into the second chamber.

6. A ferrule according to claim 5, further comprising:
an outer surface on the body between the front end and the back end;
a first opening extending through the outer surface to the first chamber; and
a second opening extending through the outer surface to the second chamber.

7. A ferrule according to claim 1, further comprising:
an outer surface on the body between the front end and back end;
a first opening extending through the outer surface to the first group of micro-holes; and
a second opening extending through the outer surface to the second group of micro-holes.

8. A ferrule according to claim 1, wherein the at least one additional end face comprises a second end face from which both the first and second groups of micro-holes extend, the second end face occupying the space between the innermost micro-hole in the first group and the innermost micro-hole in the second group.

9. A ferrule according to claim 8, wherein the second end face is non-rectangular.

10. A ferrule according to claim 9, wherein portions of the second end face from which the first and second groups of micro-holes extend are enlarged relative to a portion of the second end face occupying the space between the innermost micro-hole in the first group and the innermost micro-hole in the second group.

11. A ferrule according to claim 10, wherein the second end face is bone-shaped.

12. A ferrule according to claim 1, wherein the at least one additional end face comprises a second end face from which the first group of micro-holes extend and a third end face from which the second group of micro-holes extend, the second and third end faces being offset from the first end face in a similar manner but spaced apart from each other so as to define a gap therebetween.

13. A ferrule according to claim 12, wherein the second and third end faces have substantially the same shape.

14. A ferrule according to claim 12, wherein either or both of the second and third end faces are elliptical.

15. A ferrule according to claim 12, wherein either or both of the second and third end faces are rectangular.

16. A ferrule for an optical connector that can include multiple optical fibers, the ferrule comprising:
a body extending in a longitudinal direction between a front end and a back end, the front end defining a first end face and at least one additional endface offset from the first end face in the longitudinal direction; and
first and second groups of micro-holes extending into the body from the at least one additional end face, each micro-hole being configured to receive one of the optical fibers;
wherein the first and second groups of micro-holes are spaced apart from each other by distance greater than spacing between the micro-holes in the first and second groups themselves, and wherein the body is free of micro-holes between the first and second groups of micro-holes.

17. A fiber optic cable assembly, comprising:
a ferrule comprising:
a body extending in a longitudinal direction between a front end and a back end, the front end defining a first end face and at least one additional endface offset from the first end face in the longitudinal direction; and
first and second groups of micro-holes extending into the body from the at least one additional end face;
wherein the first and second groups of micro-holes are spaced apart from each other by distance greater than spacing between the micro-holes in the first and second groups themselves, and wherein the body is free of micro-holes between the first and second groups of micro-holes; and
optical fibers each received in one of the micro-holes of the ferrule.

18. A fiber optic cable assembly according to claim 17, wherein the ferrule is part of a fiber optic connector that also includes a housing received over the ferrule, wherein the ferrule is spring-biased within the housing so that the front end of the body of the ferrule extends beyond the housing.
